(19) United States
(12) Patent Application Publication
(10) Pub. No.: US 2012/0144855 A1
(43) Pub. Date: Jun. 14, 2012

(54) MODULAR WATER FILTER ASSEMBLY

(76) Inventors: Andrew Reinhard Krause, Louisville, KY (US); Ramesh Janardhanam, Pardeeville, WI (US); Abdel J. Hamad, Louisville, KY (US); Richard Devos, Goshen, KY (US); Alan Joseph Mitchell, Louisville, KY (US)

(21) Appl. No.: 12/965,865

(22) Filed: Dec. 11, 2010

(51) Int. Cl. F25D 23/12; B01D 36/02; B01D 35/02; B01D 25/00

(52) U.S. Cl. 62/331; 210/254; 210/253; 210/153

(57) ABSTRACT

A modular water filter assembly is disclosed. The modular water filter assembly includes a primary module having primary filter media for treating water; a secondary module having a first end and a second end; and a manifold defining an inlet connectable to a water source, and an outlet connectable to a water dispenser. The secondary module is removably coupled to the manifold at the first end thereof, and to the primary module at the second end thereof, the secondary module defining a flow path for carrying water therethrough. The water filter assembly is variably configurable for treating water passed from the water source through the inlet of the manifold and through at least one of the primary module and the secondary module and then through the outlet of the manifold. An appliance incorporating such a modular water filter assembly is also disclosed.

### BACKGROUND OF THE INVENTION

The present disclosure relates generally to a water filter assembly. More particularly, the present disclosure relates to a modular water filter assembly that includes a variably configurable structure for treating water for various purposes, and to an appliance incorporating such a modular water filter assembly.

Currently, many refrigerators include a water dispenser and an ice maker. The ice maker or the water dispenser may include a water reservoir connected to a water source, which is often a municipal water source. The refrigerator may also have a water filter through which water is passed to filter the water prior to being deposited in the water reservoir or dispensed via the water dispenser.

A problem in the art exists in that current water filters are often insufficient in that the filter may remove one type of particulate, when a user may desire that the filter treat the water for removing a different particulate, matter or pollutant. Generally, to remove various types of particulates or matter from water, different filter media may be required or preferred. Additionally, currently available water filter media differ in performance, cost, size, capacity, and lifespan. Further, a need for certain types of filters may vary from one geographic region to another and/or for use with water having differing characteristics.

Additionally, a user may want to treat water for enhancing the taste, improving the smell, or changing the color of water. Various filtering products and/or

additives are available to meet these needs, but they generally cannot be variably configured together easily.

Accordingly, what is needed is a variably configurable water filter for use in various applications and for various purposes.

### BRIEF DESCRIPTION OF THE INVENTION

As described herein, the exemplary embodiments of the present invention overcome one or more disadvantages known in the art.

One aspect of the present invention relates to a modular water filter assembly including a primary module comprising primary filter media for treating water; a secondary module comprising a first end and a second end; and a manifold defining an inlet connectable to a water source, and an outlet connectable to a water dispenser. The secondary module is removably coupled to the manifold at the first end thereof, and to the primary module at the second end thereof, the secondary module defining a flow path for carrying water therethrough. And the water filter assembly is variably configurable for treating water passed from the water source through the inlet of the manifold and through at least one of the primary module and the secondary module and then through the outlet of the manifold.

Another aspect of the present invention relates to an appliance including a water dispenser and a modular water filter assembly mounted therein. The modular water filter assembly includes a primary module comprising primary filter media for treating water; a secondary module comprising a first end, a second end, and secondary filter media; and a manifold defining an inlet connectable to a water source, and an outlet connected to the water dispenser. The secondary module is removably coupled to the manifold at the first end thereof, and to the primary module at the second end thereof, the secondary module defining a flow path for carrying water therethrough. And the water filter assembly is variably configurable for treating water passed from the water source through the inlet of the manifold and through at least one of the primary module and the secondary module and then through the outlet of the manifold to the water dispenser.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE DRAWINGS

In the drawings:

FIG. 1 is a front view of a refrigerator including an embodiment of a water filter assembly according to the present disclosure;

FIG. 2 is a front view of the refrigerator of FIG. 1 showing an embodiment of the disclosed water filter mounted therein;

FIG. 3 is a schematic view of an embodiment of a water filter assembly according to the present disclosure;

FIG. 4 is a schematic view of a primary module of the water filter assembly of FIG. 3;

FIG. 5 is a partial perspective view of another embodiment of a primary module of a water filter assembly in accordance with the present disclosure;

FIG. 6 is a schematic view of a secondary module of the water filter assembly of FIG. 3;

FIG. 7 is a schematic view of a manifold of the water filter assembly of FIG. 3;

FIG. 8 is a schematic view of another embodiment of a water filter assembly according to the present disclosure;

FIG. 9 is a schematic view of still another embodiment of a water filter assembly according to the present disclosure;

FIG. 10 is a partial perspective view of an embodiment of a manifold of the disclosed water filter assembly; and

FIG. 11 is a schematic view of yet another embodiment of a water filter assembly according to the present disclosure.

### DETAILED DESCRIPTION OF THE EMBODIMENTS OF THE INVENTION

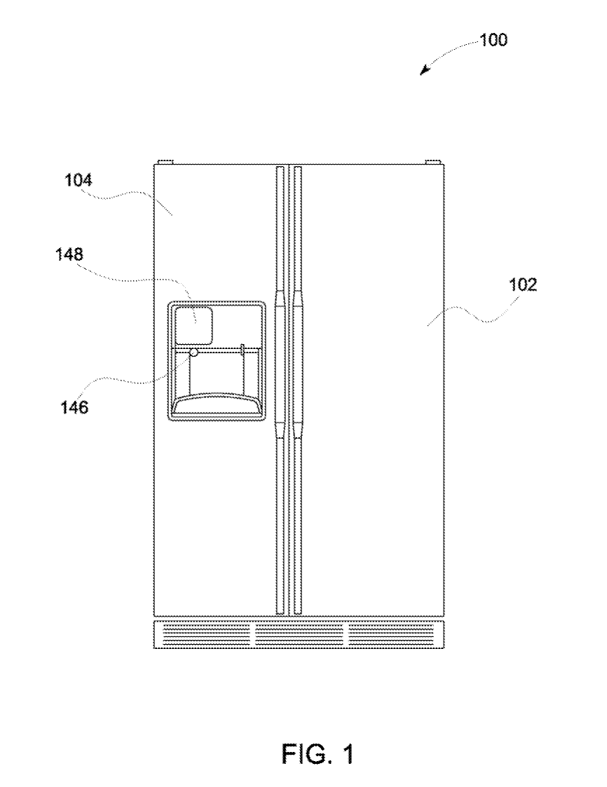

Referring to FIG. 1, refrigerator 100 includes a fresh food storage compartment 102 and a freezer storage compartment 104 arranged in a side-by-side configuration. In one embodiment, refrigerator 100 is a commercially available refrigerator from General Electric Company, Appliance Park, Louisville, Ky. 40225, and is modified to incorporate the herein described water filter assembly. Preferably, the refrigerator 100 includes a water dispenser 146 and a user interface 148.

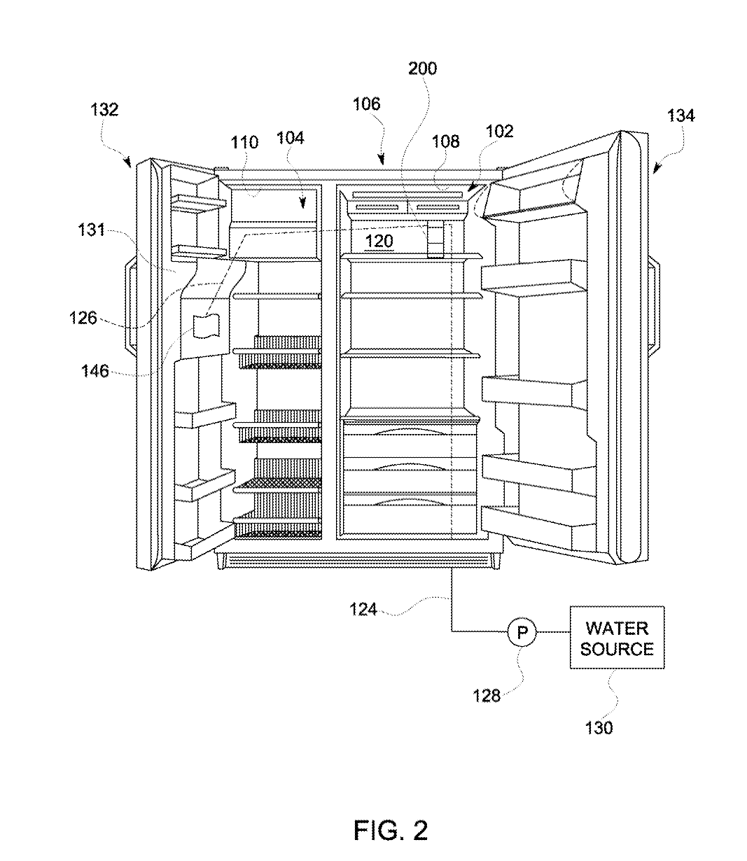

As shown in FIG. 2, the refrigerator 100 includes fresh food storage compartment 102 and freezer storage compartment 104 contained within an outer case 106 and defined in part by inner liners 108 and 110 respectively. A space between case 106 and liners 108 and 110, and between the liners 108 and 110, is filled with insulation.

In accordance with known refrigerators, refrigerator 100 also includes a machinery compartment (not shown) that at least partially contains components for executing a known vapor compression cycle for cooling air. The components include a compressor (not shown), a condenser (not shown), an expansion device (not shown), and an evaporator (not shown) connected in series and charged with a refrigerant. The evaporator is a type of heat exchanger, which transfers heat from air passing over the evaporator to a refrigerant flowing through the evaporator, thereby causing the refrigerant to vaporize. The cooled air is used to refrigerate one or more food storage or freezer compartments via fans (not shown). Collectively, the vapor compression cycle components in a refrigeration circuit, associated fans, and associated compartments are referred to herein as a sealed system. The construction of the sealed system is well known and operable to force cold air through the refrigerator 100.

The refrigerator 100 further includes a microprocessor, or controller (not shown) that is programmed to control the components of the refrigerator in accordance with pre-set or user controlled settings.

Refrigerator 100 and similar appliances are well known in the art and will not be described further herein except as necessary to describe embodiments of the disclosed water filter assembly and the operation thereof.

FIG. 2 illustrates the refrigerator 100 shown with both of a freezer door 132 and a fresh food compartment door 134 in an open position. A water filter assembly 200 according to the present disclosure is shown mounted to a rear interior wall 120 of the fresh food storage compartment 102 via a support member or bracket (not shown). A water supply line 124 is connected between an inlet of the water filter assembly 200 and a water source 130. A water line 126 is connected between an outlet of the water filter assembly 200 and the water dispenser 146. Typically, the water dispenser 146 is mounted within a housing 131 of the freezer compartment door 132 such that dispensable water is accessible from the water dispenser outside of the refrigerator 100 and without opening a door thereof as shown in FIG. 1. The water filter assembly 200 is provided to filter and/or treat water provided from the water source 130 prior to being dispensed through the water dispenser 146. A pump 128 may be provided in fluid communication with the supply line 124 to produce water pressure and move water through one or more of the water supply line 124, the water line 126, the water filter assembly 200 and the water dispenser 146.

The water dispenser 146 may also be connected to other water supply lines (not shown) for selectively providing hot or warm water to a user of the refrigerator 100. As necessary, additional water filter assemblies 200 may be utilized for treating water associated with the additional water supply lines, or multiple water lines may be coupled to the outlet of the water filter assembly 200.

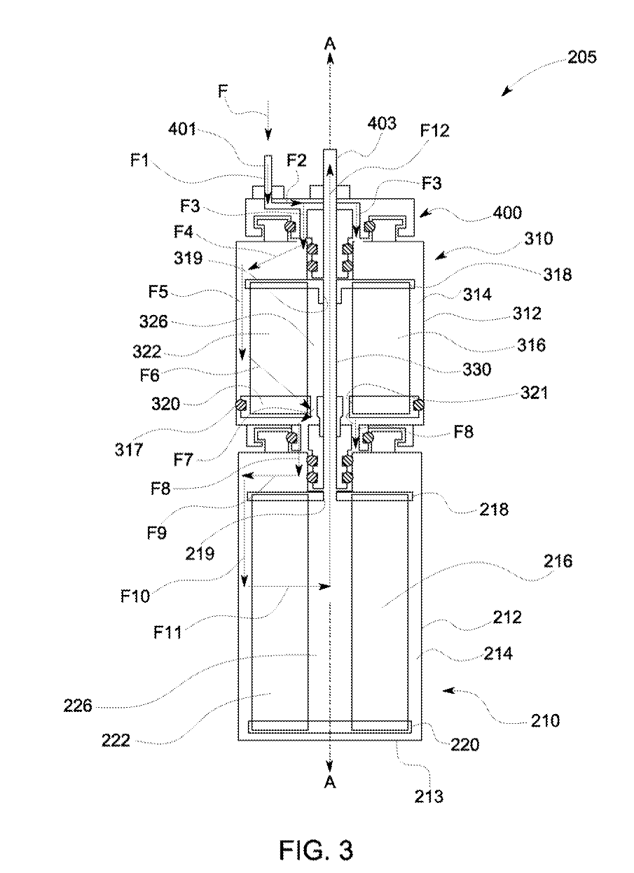

Referring to FIG. 3, a modular water filter assembly 205 includes a primary module 210 removably coupled to a secondary module 310. A manifold 400 having a water inlet 401 and a water outlet 403 is attached to the secondary module 310. A central axis “A” extends through a center of the water filter assembly 205, including through a center of each of the primary module 210, the secondary module 310 and the manifold 400.

The water inlet 401 is connectable to a water supply line 124 and water source 130 as described above with respect to the refrigerator 100. The water outlet 403 is connectable to the water line 126 and thereby the water dispenser 146 of the refrigerator 100. In other applications, the water inlet 401 and water outlet 403 of the water filter assembly 205 are connectable to a water source line, and water dispenser, respectively.

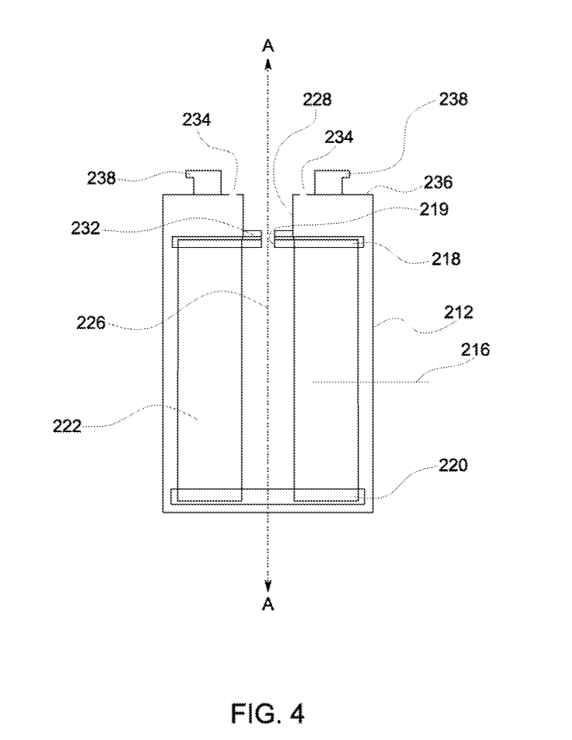

Referring to FIGS. 3 and 4, the primary module 210 includes a primary container 212 defining an interior volume 214 for holding water stored in or passing through the primary module. A primary filter 216 is disposed in the primary container 212 and is in fluid communication with water passing through the primary module 210 for treating the water. In the illustrated embodiments, the primary filter 216 includes a top cover 218 and bottom cover 220 and a primary filter media 222 attached therebetween. The top cover 218 and bottom cover 220 are impervious to water and are formed of plastic or other material such as non-corrosive metal or nylon. A seal (not shown) may be disposed between an interior wall of the primary container 212 and the bottom cover 220 of the primary filter 216 for preventing water from traveling between the bottom cover 220 and a bottom wall 213 of the primary container 212. The primary filter media 222 defines a filter opening 226 axially aligned about the axis “A” and extending through a length of the primary filter media. The top cover 218 defining a central hole 219 aligned with the filter opening 226 of the primary filter media 222 to allow water exiting the primary module 210 to pass therethrough.

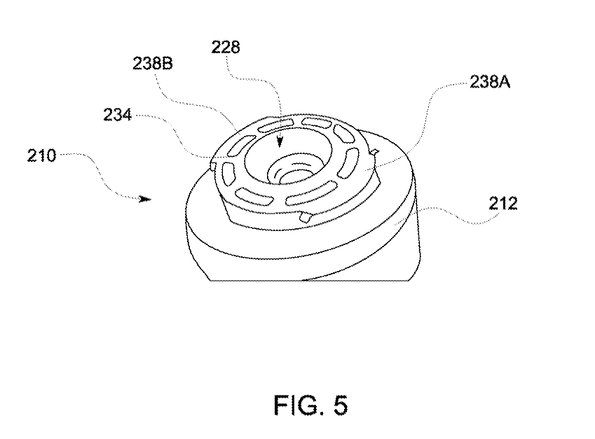

Referring to FIGS. 3-5, the primary container 212 defines an outlet 228 which is centrally disposed about the axis “A” and aligned with, and in fluid communication with the filter opening 226 of the primary filter media 222. A seal 232 is disposed between the top cover 218 of the primary filter 216 and the outlet 228 of the primary container. A top wall 236 of the primary container 212 defines a plurality of inlet openings 234 arranged circumferentially about the axis A. The inlet openings 234 being spaced apart from and radially outward of the outlet 228. A flange 238 extends outwardly from the top wall 236 of the primary container 212 for engagement with a corresponding flange opening 242 defined by a bottom wall 340 of the secondary module 310. In the FIG. 5 embodiment, the flange 238 includes two flange members 238A and 238B disposed on opposing sides of the primary container 212.

Referring to FIG. 3, the water filter assembly 205 includes the secondary module 310 coupled to the primary module 210. The secondary module includes a secondary container 312 defining an interior volume 314 for holding water stored in or passing through the secondary module. A secondary filter 316 is disposed in the secondary container 312 and is in fluid communication with water passing through the secondary module 310 for treating the water. The secondary filter 316 includes a top cover 318 and bottom cover 320 and a secondary filter media 322 attached therebetween. The top cover 318 and bottom cover 320 are impervious to water and are formed of plastic or other material such as non-corrosive metal or nylon. A seal 317 is disposed between an interior wall of the secondary container 312 and the bottom cover 320 of the secondary filter 316 for preventing water from traveling between the bottom cover 320 and a bottom wall of the secondary container 312. The seal 317 is an O-ring disposed in a cavity defined by the bottom cover 320 of the secondary filter 316 and engaged with an inside wall of the secondary container 312. The secondary filter media 322 defines a central opening 326 axially aligned about the axis “A” and extending through a length of the secondary filter media. The top cover 318 and bottom cover 320 each defining a central opening 319 and 321 respectively, the central openings being axially aligned with the central opening 326 of the secondary filter media 322 about the A axis.

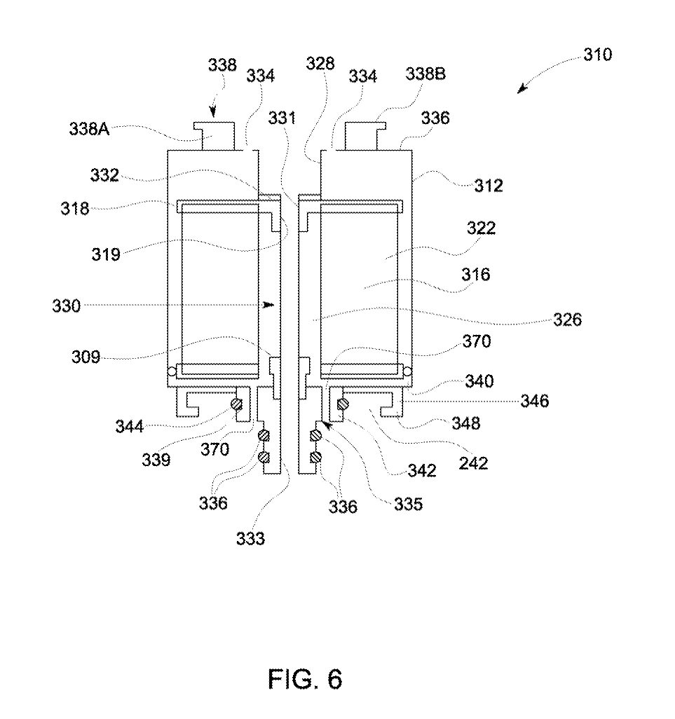

Referring to the FIGS. 3 and 6, an outlet pipe 330 extends through a height of the secondary filter 316 for carrying water exiting from the primary module 210 through the secondary module 310 and to the outlet 403 of the water filter assembly 205. The outlet pipe 330 is disposed in the central opening 326 of the secondary filter media 322 and includes an outlet end 331 that extends through the top cover 318 at the central opening 319. An outer surface of the outlet end 331 is sealably engaged with the central opening 319. The secondary container 312 defines an outlet 328, which is centrally disposed about the axis A and aligned with, and in fluid communication with the outlet pipe 330 at the outlet end 331 thereof. A seal 332 is disposed between the top cover 318 of the secondary filter 316 and the outlet 328 of the secondary container.

A top wall 336 of the secondary container 312 defines a plurality of inlet openings 334 arranged circumferentially about the axis, A which open into, and are in fluid communication with the interior volume 314 of the secondary container. The inlet openings 334 being spaced apart from and radially outward of the outlet 328.

A flange 338 extends outwardly from the top wall 336 of the secondary container 312 for engagement with a corresponding flange opening. In the FIG. 6 embodiment, the flange 338 includes two flange members 338A and 338B disposed on opposing sides of the secondary container 312. The flange 338 for coupling the secondary module 310 to the manifold 400 or another secondary module 310 depending on the configuration of the water filter assembly.

The outlet pipe 330 includes an outlet coupler 335 attached at an inlet end 333 thereof. The outlet coupler 335 is insertable into and engageable with the outlet 228 of the primary module. The outlet coupler 335 includes a pair of seals 336, 336 disposed about a perimeter of the outlet coupler for engagement with a surface of the outlet 228 of the primary module and providing a water tight seal therebetween. In the FIG. 3 embodiment, the seals 336 are O-rings. An inlet seal 309 is disposed in a corresponding opening in the bottom wall 340 of the secondary container 312 for sealing the joint where the outlet pipe 330 passes through the bottom wall.

A bottom wall 340 of the secondary container 312 defines a flange opening 242, which receives the flange 238 of the primary module 210 for connecting the primary and secondary modules together. The bottom wall 340 of the secondary container 312 further defines a plurality of outlet ports 370 which extend through the bottom wall and open into the interior volume 214 of the primary container 212. The outlet ports 370 are arranged circumferentially about the axis A radially outward of the outlet coupler 335 and aligned with the inlet openings 234 of the primary container 212 and in fluid communication therewith. The flange opening 242 is arranged radially outward of the outlet ports 370. The outlet ports 370 of the secondary container 312 and the inlet openings 234 of the primary container are in fluid communication and provide a flowpath coupling the interior volume 314 of the secondary container to the interior volume 214 of the primary container 212.

A radially inner side of the flange opening 242 being formed by a first circumferential sidewall 342 extending outwardly from the bottom wall 340 of the secondary container 312. The sidewall 342 disposed adjacent to, and radially outward of the outlet ports 370, such that the sidewall 342 in part defines the outlet ports 370. The sidewall 342 defining a groove 339 on a radially outer side thereof for carrying an O-ring seal 344 for engaging a portion of the flange 238 and sealing the coupling between the primary module 210 and secondary module 310.

The flange opening 242 being further defined on a radially outer side by a second circumferential sidewall 346 extending outwardly from the bottom wall 340 of the secondary container 312. The second circumferential sidewall 346 being disposed radially outward of the first circumferential sidewall and spaced apart therefrom. The second circumferential sidewall 346 having an annular projection 348 extending radially inward from an end of the sidewall 346 towards the axis A. The annular projection 348 engaging the flange portions 238A and 238B when the primary module 210 and secondary module 310 are coupled one to the other.

In one embodiment, the secondary module 310 includes a lower portion of the secondary container 312 including the outlet coupler 335, the flange opening 242, and the bottom wall 340 of the container 312 formed integrally from a continuous material.

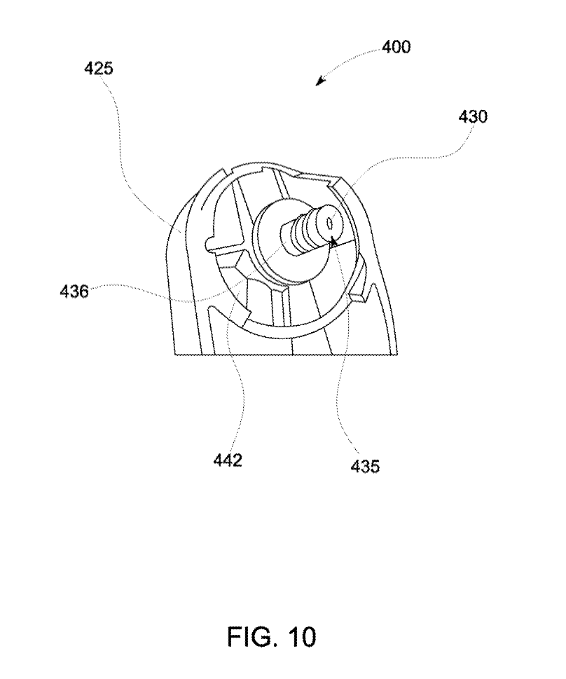

Referring to FIGS. 3, 7 and 10, the manifold 400 includes a manifold body 425 which is connectable to one of the primary module 210 and a secondary module 310 depending on the configuration of the water filter assembly. In the FIG. 3 embodiment, the water filter assembly includes the manifold 400 connected to the secondary module 310. The manifold body 425 defines a flange opening 442 similar to the flange opening 242 described above with respect to the secondary module 310 for receiving the flanges 238 or 338 of the primary and secondary modules, respectively for coupling the manifold 400 to a module of the water filter assembly.

The manifold body 425 defining an outlet pipe 430 extending through the manifold body in a direction of the axis A. The outlet pipe 430 coupled at one end to the outlet 403 and at an opposing end to an outlet coupler 435. The outlet coupler 435 attached at an inlet end 433 of the outlet pipe 430. The outlet coupler 435 being insertable into and engageable with the outlet 228 of the primary module and/or the outlet 338 of the secondary module as shown in the FIG. 3 embodiment. The outlet coupler 435 includes a pair of O-ring seals 436, 436 disposed about a perimeter of the outlet coupler for engagement with a surface of the outlet 328 of the secondary module and providing a water tight seal therebetween.

Still referring to FIG. 3, the manifold body 425 defines a flange opening 442 which receives the flange 338 of the secondary module 310 for connecting the manifold to the secondary module. The flange opening 442 defined by the manifold is equivalent to that described herein above with respect to the secondary module 310.

The manifold body 425 further defines an inlet passage 427 which extends through the manifold body and is connected to the inlet 401 at one end thereof and a plurality of outlet ports 470 at an outlet end thereof. The outlet ports 470 are adjacent to and open into the interior volume 314 of the secondary container 312 when the manifold 400 is coupled to the secondary module 310. The outlet ports 470 are arranged circumferentially about the axis A radially outward of the outlet coupler 435 and aligned with the inlet openings 334 of the secondary container 312 and in fluid communication therewith. The flange opening 442 is arranged radially outward of the outlet ports 470. The outlet ports 470 of the manifold body 425 and the inlet openings 334 of the secondary container are in fluid communication and provide a flowpath coupling the inlet 401 to the interior volume 314 of the secondary container via the inlet passage 427.

The secondary module 310 being coupled to the primary module 210 by inserting the flanges 238A and 238B of the primary module into the flange opening 242 of the secondary module and rotating one of the primary and secondary modules relative to the other thereby engaging the flange portions 238A and 238B with the annular projection 348 in a twist-lock arrangement. The secondary module 310 and primary module 210 are disassembled by rotating the primary and secondary modules relative to each other in a direction opposite that used in the assembly process.

The secondary module 310 being coupled to the manifold 400 by inserting the flanges 338A and 338B of the secondary module into the flange opening 442 of the manifold body 425 and rotating one of the manifold and secondary modules relative to the other thereby engaging the flange portions with the corresponding engagement surfaces of the flange opening 442 in a twist-lock arrangement. The secondary module 310 and manifold body 425 can be disassembled by rotating the secondary module and manifold body relative to each other in a direction opposite that used in the assembly process.

In operation, water to be processed in the water filter assembly 205 of FIG. 3 travels through the water filter assembly along a flowpath identified with the flow arrows marked “F”. At F1, water enters the water filter assembly 205 at the water inlet 401 of the manifold 400, and travels through the manifold via the inlet passage 427. (See, Flow arrow F2). Next, at flow arrow F3, the water exits the manifold 400 through the outlet ports 470 and flows into the interior volume 314 of the secondary container 312 via the inlet ports 334. The top cover 318 of the secondary filter 316 diverts the water around the top cover and towards a perimeter of the secondary container 312 as shown by flow arrow F4. The water descends about, and passes through the secondary filter 316 and into the central opening 326 defined by the filter media 322 as indicated by flow arrows F5 and F6, respectively. After passing through the secondary filter 316 and being filtered thereby, the water exits the secondary filter 316 (Flow arrow, F7) and the secondary module through the outlet port 370 (Flow arrow F8).

Next, the water enters the primary module 210 and primary container 212 via the inlet ports 234 (Flow arrow, F8). As indicated by flow arrow F9, water entering the primary container 212 is diverted towards the perimeter thereof by the top cover 218 of the primary filter 216. The water then descends about the primary filter 216 (Flow arrow, F10) and passes through the filter media 222 and into the central opening 226 as indicated by the flow arrow F11. The filter media 222 treats and/or filters the water passing therethrough depending on the characteristics and construction of the filter media. After passing through the primary filter 216, the water exits the primary filter and the primary module via the outlet 228 and is carried though the secondary module via the outlet pipe 330 and through the manifold via the outlet pipe 430 and then through the outlet 403 of the water filter assembly 205. The water flow path through the outlet pipes 330 and 430 and the outlet 403 is identified in FIG. 3 by the flow arrow F12.

As set forth above, water entering the water filter assembly 205 passes through, and is filtered by the secondary filter 316 and then into and through the primary filter 216 where the water is filtered by the primary filter. In the FIG. 3 embodiment, the water filter assembly 205 is configured in a serial filter arrangement wherein water passes first through the secondary module 310 and associated secondary filter 316 and then through the primary module 210 and associated primary filter 216 in a serial flow arrangement.

In a further embodiment (not shown) one or more additional secondary modules 310 can be added to the water filter assembly 205 and coupled in-line with the primary module 210 and secondary module 310. The additional one or more secondary modules 310 could be coupled between the manifold 400 and the secondary module 310, and/or between the secondary module 310 and primary module 210. The sequence and configuration of the secondary module(s) 310 may depend on the content of the filter media 322 thereof and a desired order of a filtering process.

The filter media 222 of the primary filter 216 and secondary filter 316 may include any type of water filtration media available and for any purpose of treating water, including to remove particulates, containments, metals, odors, toxins, or to enhance the color, odor, or taste of the water passing through the water filter assembly 205. Thus, although the primary and secondary filters 216 and 316 are described to include filter media disposed between top and bottom covers, numerous other types and configurations of filters may be used with the water filter assembly 205 including sand or aggregate, or other types of compounds disposed within the containers of the primary and secondary containers. The secondary module 310 can also function as a pre-filter, or can remove silica, or can be any porous membrane to filter out thick media.

The primary module 210 and secondary module 310 can also include a microbiological filter, a filter to remove pollutants, a filter to remove Bisphenol A (BPA) or volatile organic compounds (VOCs), a filter to remove methyl tertiary-butyl ether (MTBE), a filter to remove pesticides, a chlorine filter, an iron filter, an aluminum filter, a lead filter or can provide any additional filtration function to improve or modify a characteristic of the water passing through the water filter assembly 205.

In yet a further embodiment of the present disclosure, the primary module 210 and/or secondary module 310 can have filter media including one or more of activated carbon, coral calcium, TᵢO₂, or any other filter media known for filtering water or another liquid to be passed through the water filter assembly 205.

In yet another embodiment, either of the primary module 210 and/or the secondary module 310 may include filter media or another material to improve or change a taste or odor of the water passed through the water filter assembly.

Thus, the modular water filter assembly 205 disclosed herein should not be considered limited with respect to the configuration and/or content of the water filter media used in either of the primary module 210 and the secondary module 310.

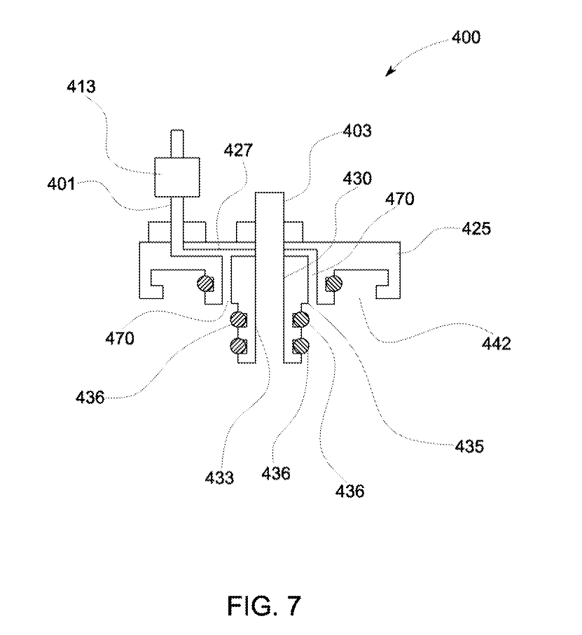

Referring to FIG. 7, a flow meter 413 is shown coupled inline with the inlet 401 of the module 400 for monitoring the amount of water flowing through the water filter assembly. The flow meter 413 may be coupled to a controller (not shown) of the refrigerator 100 and include an indicator to communicate a status of the use of one or more of the primary and secondary filters to a user of the refrigerator. Alternatively, the water filter assembly 205 may include an indicator coupled to the water flow meter 413 or another metering device for alerting a user of the water filter assembly as to a status of one or more filters used in the water filter assembly.

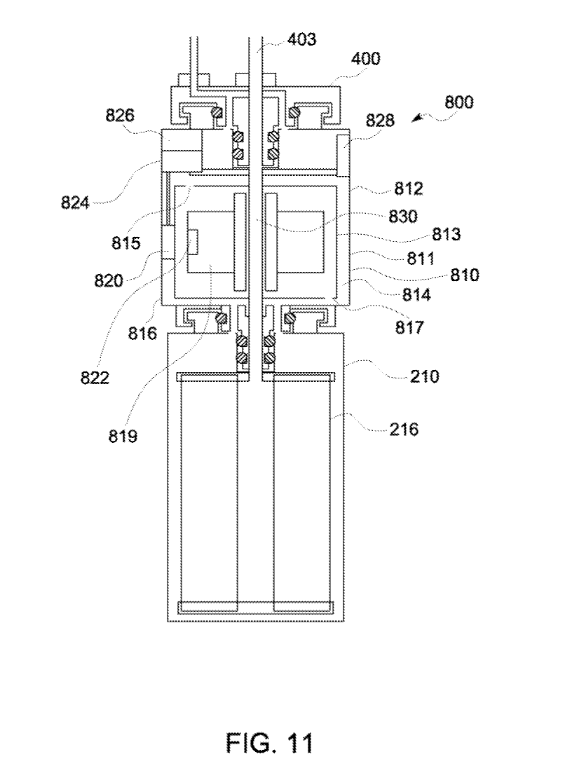

Referring to FIG. 11, a water filter assembly 800 comprises a secondary module 810 configured as a flow meter 811 for metering a volume of water passing through the water filter assembly. The water filter assembly 800 includes a manifold 400, primary module 210 and primary filter 216 as described above with respect to the water filter assembly 205 of FIG. 3. The water filter assembly 800 for treating water via the primary filter 216; the secondary module 810 being coupled to the primary module 216 and configured for serial water flow through the secondary module 810 and then through the primary module 210 as also described above with respect to the FIG. 3 embodiment. The water exiting the water filter assembly 800 through the water outlet 403.

The secondary module 810 includes the flow meter 811 in place of a filter media, however, in other embodiments, a filter media may be included within the secondary module in addition to the flow meter 811. Generally, the secondary modular 810 is similar to the secondary module 310 described above and includes all of the components thereof with the modifications described following.

The flow meter 811 includes a chamber 813 disposed within the interior volume 814 of a secondary container 816 of the secondary module 810. The chamber 813 defines an inlet 815 and outlet 817 which are fluidly connected “in-line” with the inlet and outlet ports, respectively of the secondary container 816. Thus, the water flowing into the secondary container passes through the chamber 813.

The flow meter 811 further includes a paddle wheel 819 rotatably coupled to the outlet pipe 830 for rotation thereabout. In the illustrated embodiment, a sleeve coupled to the paddle wheel 819 is disposed about the outlet pipe 830 for rotation relative about the outlet pipe. In other embodiments, a bearing or other known coupling arrangement could be used for rotably mounting the paddle wheel 819 in a flow path of the water passing through the water filter assembly 800. A cooperating sensor 820 and magnet 822 are mounted, one each, to the paddle wheel 819 and an opposing wall of the chamber 813 and/or secondary container 812. A battery 824 and controller 826 are also mounted to the secondary module 810. A display, such as LCD display 828 is coupled to the secondary module 810 for viewing by a user for determining a status of the flow meter 811 and/or the primary filter 216. Wires connect the sensor 820 and display 828 to the battery 824 and the controller 826. In other embodiments, the flow meter 811 could be coupled to a remote display such as user interface 148 of the refrigerator 100 of FIG. 1.

In operation of the flow meter 811, water flowing through the water filter assembly 800 and the chamber 813 causes the paddle wheel 819 to rotate about the outlet pipe 830. As the paddle wheel 819 revolves, the sensor 820 and magnet 822 interact resulting in an output signal from the sensor 820 corresponding to the number of revolutions of the paddle wheel and countable via the controller 826 to determine an estimate of the volume of water passing through the water filter assembly 800 and primary filter 216. The controller 826 is configured to receive and process the signal data received from the sensor 820 and transmit a filter condition signal to the display 828 to be displayed and thereby communicate to a user a status of the primary filter 216 based on the volume of water passing through the water filter assembly 800.

The display 828 may include any type of indicator to identify a status of the volume of water passing through the flow meter 811 and/or a status of the primary filter 216 based on the volume of water passed therethrough. In one embodiment, the display 828 comprises a pair of color-coded lights, such as a green LED illuminated during a period of time prior to a determination by the controller 826, that a predetermined maximum volume of water has passed through the flow meter 811 and water filter assembly 800, which is turned off and replaced with a red LED illuminated after a maximum volume of water has passed through the flow meter 811. In other embodiments, an analog or digital display may provide an indicator of the status of the primary filter 216. In another embodiment, the display 828 simply illuminates a short textual message such as “change filter” after a pre-determined volume of water has passed through the primary filter 216.

The flow meter 811 of FIG. 11 is shown as an electro-mechanical paddle wheel type meter, however, other types of flow meters may also be utilized in the water filter assembly 800 including purely mechanical or electronic flow meters or other types of hybrids thereof. Alternatively, in other embodiments of the water filter assembly 800, the condition of the primary filter 216 can be determined via a time-based or calendar method, wherein a filter condition indicator such as display 828 is coupled to a clock (not shown) and provides a signal to change the filter based on a time between filter changes.

In another embodiment, instead of containing a filter component, the primary container 212 and/or secondary container 312 may include a storage container for holding water for cooling in the food storage area of a refrigerator, for providing a supply of cold water to a water dispenser, such as the water dispenser 146 of refrigerator 100 of FIG. 2. The secondary container 312, may define an interior volume 314 having a storage capacity (e.g., of one-half gallon; or one gallon) for providing cold and filtered drinking water to a user of the refrigerator 100.

In other applications, the water filter assembly 205 may be mounted under a counter, or within another type of appliance or device, such as a cooler, or wine chiller or a stand alone bottled water dispenser.

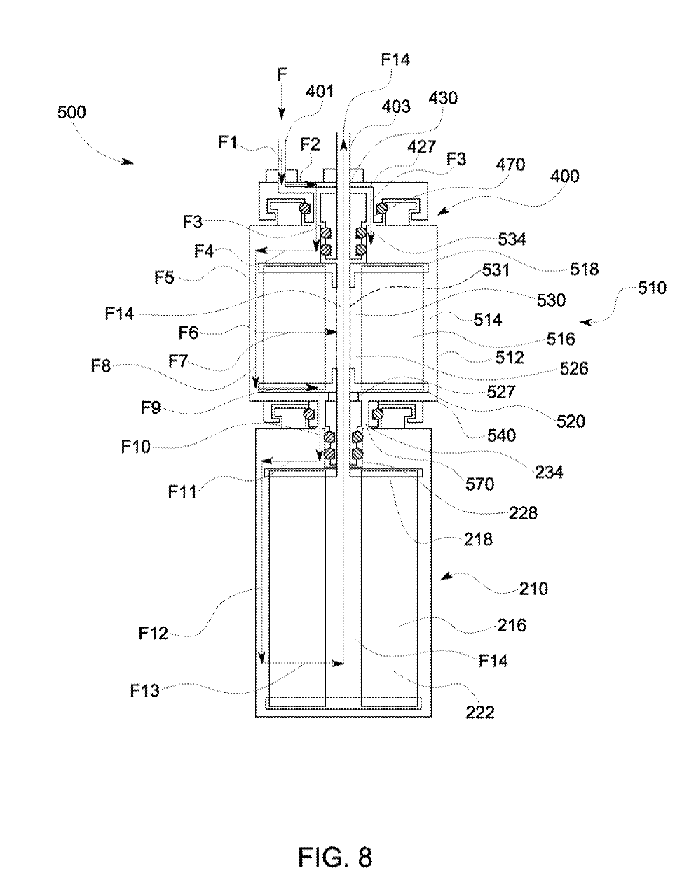

Referring to FIG. 8, a water filter assembly 500 provides for treating water through primary and secondary filters in a parallel flow arrangement. The water filter assembly 500 includes a manifold 400, primary module 210 and primary filter 216 as described above with respect to the water filter assembly 205 of FIG. 3.

The secondary module 510 of the water filter assembly 500 defines a flow path for providing a parallel flow path through the primary module 210 and secondary module 510 and the associated filter media. The secondary modular 510 is similar to the secondary module 310 described above and includes all of the components thereof with the modifications described following to the secondary filter 516 and outlet pipe 530. The primary module 210, secondary module 510 and the manifold 400 of the water filter assembly embodied in FIG. 8 are coupled together in the same way as the corresponding components of the above-described water filter assembly of FIG. 3. The modular components of the various embodiments of the water filter assemblies described herein are interchangeable, and/or connectable, one with the other, such that a water filter assembly as disclosed herein can include various configurations depending on the number and configuration of secondary modules included in the water filter assembly.

Referring to FIG. 8, the outlet pipe 530 defines a plurality of perforations 531 for allowing water passing through the secondary filter media 522 and entering the central opening 526 to pass through the perforations 531 and into the stream of water flowing in the outlet pipe 530. The water in the outlet pipe 530 is carried through the manifold 400 and exits the water filter assembly through the outlet 403 of the manifold as described above.

The secondary filter 516 includes a continuous bottom cover 520 which prevents water passing through the secondary filter 516 and secondary filter media 522 from exiting the secondary module 510 via the output ports 370 of the secondary container 512. Thus, water passing through the secondary filter exits the secondary filter 522 and secondary module 510 via the outlet pipe 530 without passing through and/or being filtered or treated by the primary module 210.

In using the water filter assembly 500 of FIG. 8, water travels through the water filter assembly along a flowpath identified with the arrows marked “F”. At F1, water enters the water filter assembly 205 at the water inlet 401 of the manifold 400, and travels through the manifold via the inlet passage 427. (See, Flow arrow F2). Next, at flow arrows F3, the water exits the manifold 400 through the outlet ports 470 and flows into the interior volume 514 of the secondary container 512 via the inlet ports 534. The top cover 518 of the secondary filter 516 diverts the water around the top cover and towards a perimeter of the secondary container 512 as shown by flow arrow F4. The water descends about the secondary filter 516 (Flow arrow, F5) and splits (See, Flow point F6) with a portion of the water entering and passing through the secondary filter media 512 and into the central opening 526 defined by the filter media 522 as indicated by flow arrow F7. After passing through the secondary filter 516 and being filtered thereby, the water exits the secondary filter 516 through the perforations 531 in the outlet pipe 530 and is thereafter carried by the outlet pipe 530 and continues to exit the secondary module 510 and manifold 400 through the outlet pipe 430 and outlet 403 (Flow arrow F14).

The portion of water passing by the secondary filter 510 at the split (e.g., at flow point F6) passes under the secondary filter 516 (Flow arrow, F9) and exits the secondary module through the outlet ports 570 of the secondary container 512 (Flow arrow, F10). A shoulder 527 supports the secondary filter 516 and provides a flowpath between the secondary filter and a bottom wall of the secondary container 540.

Next, the water enters the primary module 210 and primary container 212 via the inlet ports 234 (Flow arrow, F10). As indicated by flow arrow F11, water entering the primary container 212 is diverted towards the perimeter thereof by the top cover 218 of the primary filter 216. The water then descends about the primary filter 216 (Flow arrow, F12) and passes through the filter media 222 and into the central opening 226 as indicated by the flow arrow F13. The filter media 222 treats and/or filters the water passing therethrough depending on the characteristics and construction of the filter media. Following passing through the primary filter 216, the water exits the primary filter and the primary module via the outlet 228 and is carried though the secondary module via the outlet pipe 530 and through the manifold via the outlet pipe 430 and then through the outlet 403 of the water filter assembly 500. The water flow path through the outlet pipes 530 and 430 and the outlet 403 is identified in FIG. 8 by the flow arrow F14.

As set forth above, water entering the water filter assembly 500 passes through, and is filtered by the either of the secondary filter 516 or the primary filter 216 and thereafter exits the water filter assembly 500 via the outlet 403. In the FIG. 8 embodiment, the water filter assembly 500 is configured in a parallel filter arrangement wherein water passes first through one of the secondary module 510 and associated secondary filter 516 OR through the primary module 210 and associated primary filter 216. In one embodiment of the water filter assembly 500, the filter media 522 of the secondary filter 516 and the filter media 222 of the primary filter 216 are similar so as to filter the water passing through each of the primary and secondary filters substantially to the same extent and for the same purpose. Alternatively, the primary and secondary filters 216 and 516 respectively, may be different one from the other and provide different functions for treating water.

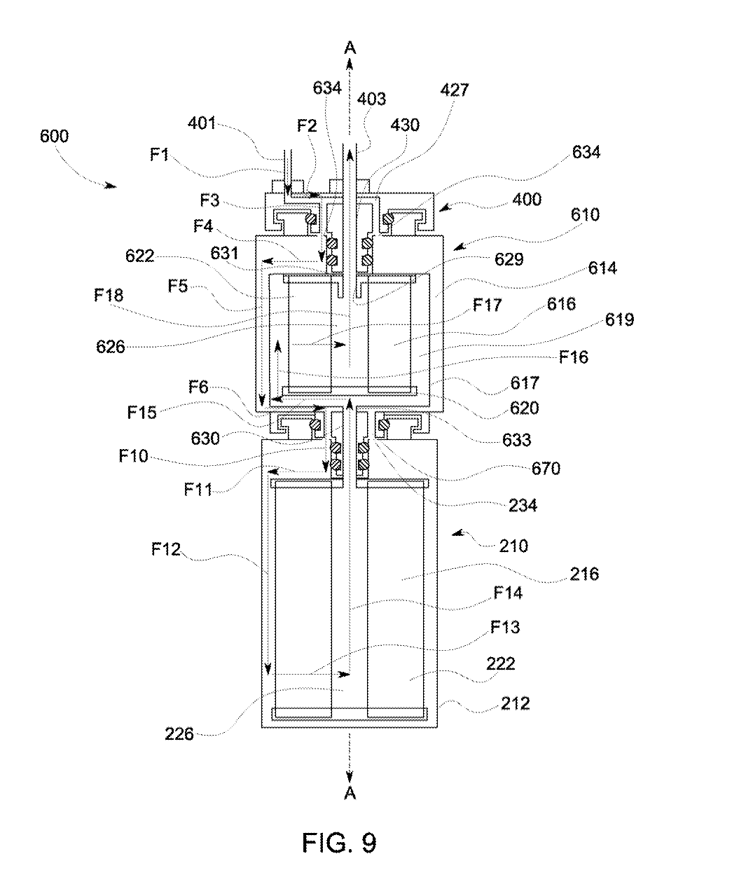

Referring to FIG. 9, a water filter assembly 600 provides for treating water through primary and secondary filters in a reverse serial flow arrangement as described further following. The water filter assembly 600 includes a manifold 400, primary module 210 and primary filter 216 as described above with respect to the water filter assembly 205 of FIG. 3.

The secondary module 610 of the water filter assembly 600 defines a flow path for providing a reverse serial flow path through the water filter assembly such that water entering the water filter assembly is initially passed through the secondary module without filtering and into the primary module 210 and associated filter first and then back through the secondary module 610 and associated secondary filter 616. After passing through the secondary filter 616, the water exits the water filter assembly through the water outlet 403. Thus, the water filter assembly 600 treats/filters water serially, first through the primary filter 216 and then through the secondary filter 616.

The secondary modular 610 is similar to the secondary module 310 described above and includes all of the components thereof with the modifications described following. The primary module 210, secondary module 510 and manifold 400 are coupled together in the same fashion as the corresponding components of the water filter assemblies 205 and 500 described above. The configuration of the secondary module 610 and the flowpath defined thereby are described following.

The secondary container 612 includes a filter housing 617 defining an interior volume 619 and disposed inside the interior volume 614 of the secondary container. The filter housing 617 is fluidly connected “in-line” with the outlet pipe 630 passing through the secondary module 610 and defines inlet and outlet ports (633, 631) aligned with the axis A and in fluid communication with the outlet 228 of the primary container and an outlet 628 of secondary container 612, respectively. Thus, water exiting the primary container 212 flows into the interior volume 619 of the filter housing 618 through the inlet port 633 defined in a bottom wall of the filter housing.

The secondary filter 616 is disposed in the interior volume 619 of the filter housing 617. The secondary filter 616 having a top cover 618 and bottom cover 620 and a filter media 622 attached between the top and bottom covers. The filter media 622 defining a filter opening 626 extending along the axis “A” throughout a height of the secondary filter media. The bottom cover 620 being continuous and impervious to water. The top cover 618 defining a central opening 629 sealably coupled to the outlet port 633 of the filter housing 617 such that the filter opening 626 is in fluid communication with the outlet pipe 430 of manifold 400.

In operation, water to be processed in the water filter assembly 600 of FIG. 9 travels through the water filter assembly along a flowpath identified with the flow arrows marked “F”. At F1, water enters the water filter assembly 600 at the water inlet 401 of the manifold 400, and travels through the manifold via the inlet passage 427. (See, Flow arrow F2.) Next, at flow arrow F3, the water exits the manifold 400 through the outlet ports 470 and flows into the interior volume 614 of the secondary container 612 via the inlet ports 634. The filter housing 617 diverts the water towards a perimeter of the secondary container 612 and around the filter housing as shown by flow arrow F4. The water descends along the outside perimeter, and below the filter housing 617 as shown by flow arrows F5 and F6, respectively. Next, the water exits the secondary module 610 through the outlet ports 670 of the secondary container 612 (Flow arrow, F10).

Thereafter, the water enters the primary module 210 and primary container 212 via the inlet ports 234 (Flow arrow, F10). As indicated by flow arrow F11, water entering the primary container 212 is diverted towards the perimeter thereof by the top cover 218 of the primary filter 216. The water then descends about the primary filter 216 (Flow arrow, F12) and passes through the filter media 222 and into the central opening 226 as indicated by the flow arrow F13. The filter media 222 treats and/or filters the water passing therethrough depending on the characteristics and construction of the filter media. Following passing through the primary filter 216, the water exits the primary filter and the primary module via the outlet 228 and is carried into the secondary module 610 via the outlet pipe 630.

The water entering the secondary module 610 enters via the inlet port 633 of the filter housing 617 and into the interior volume 619 thereof. (Flow arrow, F14). The bottom cover 620 of the secondary filter 616 diverts the water towards the outer perimeter of the filter housing 617 as shown by the flow arrow F15. The water then ascends along a perimeter of the secondary filter media 622 and between an interior side wall of the filter housing 617 and the secondary filter media 622 (Flow arrow, F16) and thereafter continues into and through the secondary filter media 622 (Flow arrow, F17). Water passing through the secondary filter media 622 flows into and through the filter opening 626 of the filter media and exits the secondary filter via the outlet opening 629 and 631 of the top cover 618 and filter housing, respectively. The water then flows into the fluidly connected outlet pipe 430 of the manifold 400 and exits the water filter assembly 600 via the outlet 403. The water flow path for water exiting the secondary filter 616 and into and through the outlet pipe 430 and the outlet 403 is identified in FIG. 8 by the flow arrow F18.

As set forth above, water entering the water filter assembly 600 passes through the secondary module 610 without filtering initially and into the primary module 210 where the water passes through and is filtered by the primary filter 216 and thereafter re-enters the secondary module and is passed through and filtered by the secondary filter 216. Thus, in the FIG. 9 embodiment, the water filter assembly 600 is configured in a “reverse” serial filter arrangement when compared to the serial filter arrangement of the water filter assembly of FIG. 3 (i.e., in the FIG. 3 embodiment, water entering the water filter assembly 205 is passed through the secondary filter 312 first and then through the primary filter 212, whereas in the FIG. 9, embodiment, the water entering the water filter assembly 600 is passed first through the primary filter 212 and then through the secondary filter 612).

In the illustrated embodiments, the water filter assemblies 205, 500 and 600 are shown with one primary module 210 and one secondary module (e.g., 310, 510, 610), however, as set forth above, multiple secondary modules can be coupled one to the other and included in a single water filter assembly. Each of the multiple secondary components can define one of the serial, parallel or reverse serial configurations set forth herein and each can include distinct secondary filter media for providing various water filtration and/or improving the taste or odor of the water passed therethrough. Accordingly, various configurations of the water filter assembly are possible and within the scope of the present disclosure.

Water traverses through the first filter component 206 and the second filter component 210. The present disclosure is discussed in terms of water; however, it should be appreciated that this forms no limitations to the present disclosure and other filterable liquids may be processed in various embodiments of the filter assembly disclosed.

Thus, while there have shown and described and pointed out fundamental novel features of the invention as applied to exemplary embodiments thereof, it will be understood that various omissions and substitutions and changes in the form and details of the devices illustrated, and in their operation, may be made by those skilled in the art without departing from the spirit of the invention. Moreover, it is expressly intended that all combinations of those elements and/or method steps which perform substantially the same function in substantially the same way to achieve the same results are within the scope of the invention. Furthermore, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A modular water filter assembly comprising:
a primary module comprising primary filter media for treating water;
a secondary module comprising a first end and a second end; and
a manifold defining an inlet connectable to a water source, and an outlet connectable to a water dispenser,
wherein the secondary module is removably coupled to the manifold at the first end thereof, and to the primary module at the second end thereof, the secondary module defining a flow path for carrying water therethrough, and
wherein the water filter assembly is variably configurable for treating water passed from the water source through the inlet of the manifold and through at least one of the primary module and the secondary module and then through the outlet of the manifold.

2. The modular water filter assembly of claim 1, wherein the secondary module comprises secondary filter media for treating water.

3. The modular water filter assembly of claim 2, wherein at least one of the primary filter media and the secondary filter media comprises a compound for improving the taste of water.

4. The modular water filter assembly of claim 2, wherein at least one of the primary filter media and the secondary filter media comprises a compound for improving the smell of water.

5. The modular water filter assembly of claim 2, wherein at least one of the primary filter media and the secondary filter media comprises a filter for removing particulates from water.

6. The modular water filter assembly of claim 2, wherein the flow path defined by the secondary module is configured to direct water to flow through the secondary filter media and then through the primary filter media.

7. The modular water filter assembly of claim 2, wherein the flow path defined by the secondary module is configured to direct water to flow through the primary filter media and then through the secondary filter media.

8. The modular water filter assembly of claim 2, wherein the flow path defined by the secondary module is a split flow path wherein a portion of the water flowing into the inlet passes through the secondary filter media and the remainder of the water flowing into the inlet passes through the primary filter media.

9. The modular water filter assembly of claim 1, wherein the secondary module further comprises a flow meter for measuring a volume of water passing through the water filter assembly.

10. The modular water filter assembly of claim 1, wherein the modular water filter assembly comprises multiple secondary modules coupled to each other in series and between the manifold and the primary module.

11. The modular water filter assembly of claim 1, wherein the modular water filter assembly comprises multiple secondary modules coupled to each other for treating water passed through the water filter assembly for various purposes depending on contents of secondary filter media of the multiple secondary modules.

12. The modular water filter assembly of claim 11, wherein the sequence of a filtering process through the primary module and the secondary module is variable based on the number and configuration of the secondary modules.

13. The modular water filter assembly of claim 1, wherein the secondary module comprises a storage container for storing water therein.

14. An appliance comprising a water dispenser and a modular water filter assembly mounted therein, the modular water filter assembly comprising:
a primary module comprising primary filter media for treating water;
a secondary module comprising a first end, a second end, and secondary filter media; and
a manifold defining an inlet connectable to a water source, and an outlet connected to the water dispenser,
wherein the secondary module is removably coupled to the manifold at the first end thereof, and to the primary module at the second end thereof, the secondary module defining a flow path for carrying water therethrough, and
wherein the water filter assembly is variably configurable for treating water passed from the water source through the inlet of the manifold and through at least one of the primary module and the secondary module and then through the outlet of the manifold to the water dispenser.

15. The appliance of claim 14, wherein the appliance is a refrigerator.

16. The appliance of claim 15, wherein the flow path defined by the secondary module is configured to direct water to flow through the secondary filter media and then through the primary filter media.

17. The appliance of claim 15, wherein the flow path defined by the secondary module is configured to direct water to flow through the primary filter media and then through the secondary filter media.

18. The appliance of claim 15, wherein the flow path defined by the secondary module is a split flow path wherein a portion of the water flowing into the inlet passes through the secondary filter media and the remainder of the water flowing into the inlet passes through the primary filter media.

19. The appliance of claim 15, wherein the modular water filter assembly comprises multiple secondary modules coupled to each other for treating water passed through the water filter assembly for various purposes depending on contents of secondary filter media of the multiple secondary modules.

20. The appliance of claim 14, wherein the secondary module further comprises a flow meter for measuring a volume of water passing through the water filter assembly.
